(19) United States
(12) Patent Application Publication
(10) Pub. No.: US 2024/0319690 A1
(43) Pub. Date: Sep. 26, 2024

(54) METHOD FOR CONTROLLING A MEASURING DEVICE AND MEASURING DEVICE

(71) Applicant: NETZSCH-Gerätebau GmbH, Selb (DE)

(72) Inventors: Martin BRUNNER, Konradsreuth (DE); Thomas DENNER, Selb (DE); Thilo HILPERT, Selb (DE); Fabian WOHLFAHRT, Rehau (DE); Michael SCHÖNEICH, Selb (DE); Michael MÜLLER, Trabitz (DE); Thorsten HACHMANN, Thierstein (DE)

(21) Appl. No.: 18/609,187

(22) Filed: Mar. 19, 2024

Related U.S. Application Data
(60) Provisional application No. 63/453,488, filed on Mar. 21, 2023.

(30) Foreign Application Priority Data
Mar. 21, 2023 (DE) 102023107051.7

(51) Int. Cl. G05B 15/02

(52) U.S. Cl. CPC G05B 15/02

(57) ABSTRACT

A method for controlling a measuring device includes receiving a request to determine a specific measured value by a controller, establishing by the controller a parameter list of parameters of the measuring device to be set in order to be able to determine the specific measured value, and outputting the established parameter list to a user of the measuring device by the controller. A measuring device is also disclosed.

### TECHNICAL FIELD

The disclosure herein relates to a method for controlling a measuring device and to a measuring device.

### BACKGROUND

The determination of properties of different materials is of major importance for many applications in research and industry. For this purpose a variety of measuring devices are used which, depending on the application, sometimes provide very complex measuring processes.

Performing these measurements by a user requires a certain level of expertise, since ensuring the successful completion of the desired measurement involves taking into account the technical and scientific background of the individual measurement processes.

One of the consequences thereof is that what is required to perform a measurement is not only the pure measuring time, but also a sometimes long preparation time, during which a user of a measuring device to be used must first determine which measuring method is to be used to determine a measured value and how this can be implemented.

### SUMMARY

Against this background, it is the object of the disclosure herein to facilitate the use of measuring devices and to make them more efficient.

This task is solved by a method and by a measuring device having features disclosed herein.

Accordingly, a method for controlling a measuring device is provided. The method comprises receiving a request to determine a specific measured value by a controller, establishing by the controller a parameter list of parameters of the measuring device to be set in order to be able to determine the specific measured value, and outputting the established parameter list to a user of the measuring device by the controller.

Furthermore, a measuring device is provided which is configured to perform the method according to the disclosure herein.

A parameter of the measuring device is understood here to mean any setting that is set on the measuring device or its components and can affect the measurement to be performed. This includes factors such as temperature or pressure, which may prevail in a sample receiving device of the measuring device during the measuring process. Parameters of the measuring device can also be information about the supply amount and/or the supply period of thermal, electrical and/or mechanical energy during the measuring process of a sample to be examined or information about properties of the measured values of the sample to be examined, for example in the event that the desired measured value cannot be measured directly, but can only be derived indirectly via the measurement of other properties of the sample. In principle, by establishing the parameter list, the controller can specify the process with which the desired measured value can be determined.

It is an underlying idea of the disclosure herein that the user of the measuring device is supported by a controller designed for this purpose. As the controller communicates to the user which parameters of the measuring device need to be set, this step can be drastically shortened during the measurement preparation. The output of the parameter list to the user, which can also be carried out during the measuring process, additionally relieves the user during the performance of the measurement.

According to an example embodiment of the method, the request to determine a specific measured value further comprises information regarding the desired measurement accuracy and/or measurement duration. This information is advantageously useful for establishing the list of suitable parameters for the measuring device.

According to an example embodiment of the method, the controller accesses a database when establishing the parameter list. The establishing of a suitable parameter list can be advantageously supported by a suitable configuration of the database.

According to a further development of the method, the database comprises a plurality of information on material properties and measurement methods, with the controller autonomously establishing the parameter list based on this plurality of information. As a result, the controller can advantageously support a plurality of hypothetically possible measurements.

According to one embodiment of the method, the controller updates the database after the measurement has been performed. As a result, knowledge gained during a measurement can be used to advantage for future measurements.

According to an example embodiment of the method, monitoring of measurement parameters during the determination of the measured value by a sensor device of the measuring device and evaluating of the monitored measurement parameters by the controller are also provided. The term “measurement parameters” refers on the one hand to the parameters of the measuring device as explained above, but it can also refer to properties, such as temperatures, of the measuring device itself or its components. As a result, the controller can support the user even more advantageously in determining the measured value.

According to a further development of the method, the controller issues a warning if the monitored measurement parameters deviate from the parameters in the established parameter list. As a result, incorrect measurements can be avoided.

According to a further development of the method, the controller interrupts the determination of the measured value if the monitored measurement parameters deviate from the parameters in the established parameter list. As a result, incorrect measurements can be avoided.

According to a further development of the method, the controller autonomously changes the parameters of the measuring device if the monitored measurement parameters deviate from the parameters of the established parameter list. As a result, incorrect measurements can be avoided.

### BRIEF DESCRIPTION OF THE DRAWINGS

The disclosure herein is explained below with reference to the figures of the drawings. In the figures:

FIG. 1 is a schematic flow diagram for a method according to an example embodiment of the disclosure herein;

FIG. 2 is a schematic representation of a measuring device according to an example embodiment of the disclosure herein; and

FIG. 3 is a schematic representation of a system with a plurality of measuring devices according to an example embodiment of the disclosure herein.

In the figures, the same reference signs designate identical or functionally identical components, unless indicated to the contrary.

### DETAILED DESCRIPTION

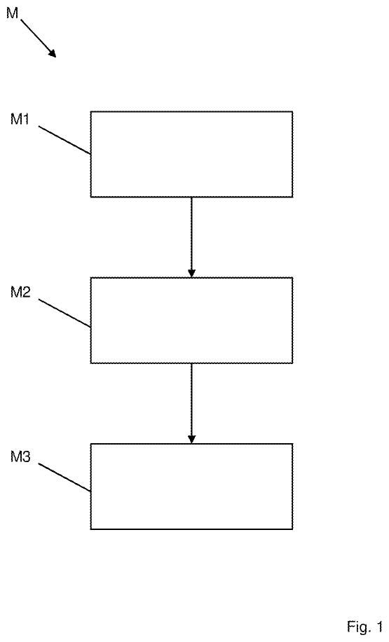

FIG. 1 shows a schematic flow diagram for a method M for controlling a measuring device according to an example embodiment of the disclosure herein.

In a first method step M1, a controller receives a request to determine a specific measured value. In a further method step M2, the controller establishes a parameter list of parameters of the measuring device to be set in order to be able to determine the specific measured value. In a further method step M3, the controller outputs the established parameter list to a user of the measuring device.

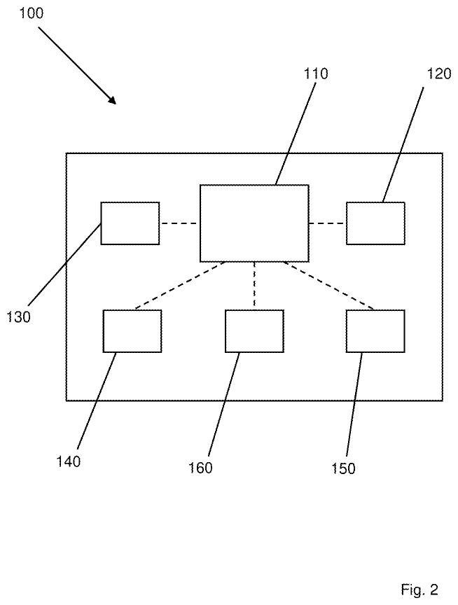

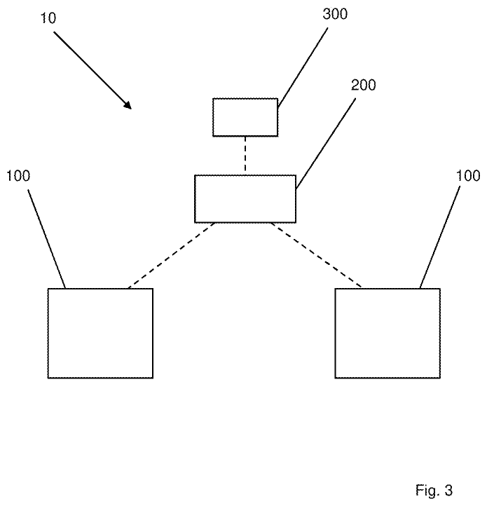

The method M shown is described in detail below with reference to FIGS. 2 and 3.

FIG. 2 shows a schematic representation of a measuring device 100 according to an example embodiment of the disclosure herein.

The measuring device 100 comprises a controller 110, a database 120, a sensor device 130, an outputting device 140, an inputting device 150, and a sample receiving device 160.

In the example embodiment shown here, the controller 110 is integrated into the measuring device 100 and is configured to receive a request to determine a specific measured value. This request can be transmitted by a user of the measuring device 100 to the controller 110, for example via the inputting device 150 of the measuring device 100. The inputting device 150 may comprise, for example, a keyboard, a touch screen or the like. Alternatively, the request can also be transmitted to the controller 110 via an external interface.

The controller 110 is further configured to establish a parameter list in response to the request received, which parameters of the measuring device are to be set in order to be able to determine the specific measured value. For this purpose, the controller 110 can access the database 120, which in the present example embodiment is configured in the form of an internal memory of the measuring device 100. The database 120 can comprise a plurality of information on material properties and measurement methods. In this case, the controller autonomously establishes the parameter list based on this plurality of information. During this process, the controller 110 could possibly also determine that the desired measured value cannot be determined at all with the measuring device 100. In this case, a corresponding notification can also be outputted instead of a parameter list.

The controller 110 is further configured to output the established parameter list to a user of the measuring device 100. For example, the outputting device 140 of the measuring device 100 can be used for this purpose. The outputting device 140 may comprise, for example, a screen and/or speakers for this purpose. For example, the outputting device 140 and the inputting device 150 may also be combined in a touchscreen. Alternatively or additionally, individually components of the measuring device 100, such as the inputting device 150 and the sample receiving device 160, can also be highlighted, for example by illuminating buttons to be actuated or the like.

In particular, the controller 110 may also be configured to update the database 120 after the specific measurement has been performed. The measurement results relating to the material properties of the sample used in the measurement can then be recorded in the database 120, for example, and are then available for future measurements and measurement schedules. Predetermined measurement schedules can also be revised, taking into account the measurement carried out. The information required for this regarding the measurement performed can either be transmitted to the controller 110 by a user of the measuring device 100. Alternatively or additionally, the controller 110 can also receive the relevant information directly from the measuring device 100, in particular from the sensor device 130.

The sensor device 130 is configured to monitor measurement parameters while determining the measured value. In this case, the controller 110 can be configured to evaluate the monitored measurement parameters. This can enable the controller 110 to output a warning if the monitored measurement parameters deviate from the parameters in the established parameter list. Alternatively or additionally, the controller 110 can also interrupt the determination of the measured value if the monitored measurement parameters deviate from the parameters in the established parameter list. As a further alternative or additional functionality, the controller 110 can be configured to autonomously change the parameters of the measuring device 100 if the monitored measurement parameters deviate from the parameters of the established parameter list.

The measuring device 100 can be configured in particular as a device for the thermal analysis of materials. In particular, the measuring device 100 may be configured to perform differential thermal analyses, dynamic differential calometry, dynamic mechanical analyses, thermomechanical analyses or the like. During such measuring processes, the support of a user by the controller 110 can be particularly advantageous.

FIG. 3 shows a schematic representation of a system 10 with a plurality of measuring devices 100 according to an example embodiment of the disclosure herein.

In the example embodiment shown, the system 10 comprises a total of two measuring devices 100, a controller 200 and a database 300.

The individually components of the system 10 can in principle be configured in exactly the same way as the corresponding components described with reference to FIG. 2. Only the controller 200 and the database 300 are configured as independent devices external to the two measuring devices 100 in the example embodiment shown here. In principle, however, the database 300 can also be configured as a sub-component of the controller 200.

Since the controller 200 is configured as a stand-alone device, it can be configured for use with either of the two measuring devices 100. In this configuration, the parameter list established by the controller 200 may include which of the measuring devices 100 is to be used.

FIG. 3 shows two measuring devices 100. However, any number of measuring devices 100 can be provided. In particular, it may also be foreseen to use an individually measuring device 100 with an external controller 200 and/or an external database 300.

The measuring devices 100 can be configured to have the same function or be configured to perform different measurements in each case. Depending on the application, this allows the respective measurement processes to be performed simultaneously or sequentially.

The database 300 is shown here as a specific component of the system 10. However, it is also conceivable that the controller 200 and/or the database 300 is connected to an extended network, in particular to the Internet, and obtains relevant information directly via this network instead of storing it locally.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 system
100 measuring device
110 controller
120 database
130 sensor device
140 outputting device
150 inputting device
160 sample receiving device
200 controller
300 database
M method
M1 method step
M2 method step
M3 method step

1. A method for controlling a measuring device, comprising:
receiving a request to determine a specific measured value by a controller;
establishing by the controller a parameter list of parameters of the measuring device to be set in order to be able to determine the specific measured value; and
outputting the established parameter list to a user of the measuring device by the controller.

2. The method according to claim 1, wherein the request to determine a specific measured value further comprises information regarding desired measurement accuracy and/or measurement duration.

3. The method according to claim 1, wherein the controller accesses a database when establishing the parameter list.

4. The method according to claim 3, wherein the database comprises a plurality of information regarding material properties and measurement methods, and the controller autonomously establishes the parameter list based on the plurality of information.

5. The method according to claim 3, wherein the controller updates the database after determining the measured value.

6. The method according to claim 1, further comprising:
monitoring measurement parameters during the determination of the measured value by a sensor device of the measuring device; and
evaluating the monitored measurement parameters by the controller.

7. The method according to claim 6, wherein the controller outputs a warning if the monitored measurement parameters deviate from the parameters of the established parameter list.

8. The method according to claim 6, wherein the controller interrupts the determination of the measured value if the monitored measurement parameters deviate from the parameters of the established parameter list.

9. The method according to claim 6, wherein the controller autonomously changes the parameters of the measuring device if the monitored measurement parameters deviate from the parameters of the established parameter list.

10. A measuring device configured to perform the method according to claim 1.
